(19) United States
(12) Patent Application Publication
(10) Pub. No.: US 2006/0016665 A1
(43) Pub. Date: Jan. 26, 2006

(54) Coin validator comprising a string sensor

(76) Inventors: Roland Griese, Berlin (DE); Dietmar Trenner, Berlin (DE)

Correspondence Address: Andrew R Basile;Young & Basile, Suite 624, 3001 West Big Beaver Road, Troy, MI, 48084, US

(21) Appl. No.: 10/524,761

(22) PCT Filed: Aug. 12, 2003
(86) PCT No.: PCT/EP03/08960

§ 371 Date: Mar. 31, 2005

(30) Foreign Application Priority Data
Aug. 13, 2002 (DE) 102375682

(51) Int. Cl. G07F 1/04

(52) U.S. Cl. 194/344

(57) ABSTRACT

The invention relates to a coin validator comprising a string sensor, which is arranged in the area of the coin insertion channel, and comprising a coin validating device for controlling the acceptance or rejection of an inserted coin. The string sensor comprises a first tooth, which is placed on a stationary part of the coin insertion channel, a second tooth, which is placed on a pendulum and which is disengaged when a coin is inserted, and comprises a switching device, which is actively connected to the pendulum and which furnishes a signal to the coin validating device when a coin is inserted. The pendulum is a component of a coin insertion funnel that, as a wearing part, is detachably connected to the housing of the coin validator and forms a part of the coin insertion channel. The pivot point of the pendulum coupled to the remaining part of the coin insertion funnel is, when viewing the cross-section, laterally offset with regard to the first and second tooth in such a manner that when the second tooth moves, in the direction of insertion of the coin downward in an arc-like manner, it disengages from the first tooth or when the second tooth moves upward in an arc-like manner, it engages with the first tooth.

The invention relates to a coin validator having a thread sensor according to the preamble of the main claim.

A coin validator with a thread sensor is known from U.S. Pat. No. 4,298,116, in which a pendulum is suspended in an articulated manner within the coin insertion channel, the pendulum being provided with a toothing. A corresponding toothing is formed in the boundary wall of the coin insertion channel and the toothings on the pendulum and in the boundary wall engage in each other in the inoperative state. A lever arm with an angled-off end is formed on the side of the pendulum which is opposite the toothing, the angled-off end interrupting the light extension of a light barrier in the inoperative state of the pendulum. If a normal coin is inserted, the pendulum is deflected and the receiver of the light barrier receives the no longer interrupted light beam and emits a corresponding signal. After passage of the coin, the pendulum pivots back into the initial position and the light barrier is interrupted again. An evaluation device evaluates the signals emitted from the light barrier together with the signals of the validating devices for the validity of the coins, which devices are disposed subsequently in the coin course. If a coin which is suspended on a thread is inserted into the coin validator, the pendulum is deflected in the same manner but the lever does not go back into its initial position with respect to the light barrier since the thread disturbs the engagement of the toothings. The light barrier is therefore not interrupted again and the evaluation device of the coin validator can adopt corresponding measures.

The object underlying the invention is to produce a coin validator with a thread sensor which reliably detects a thread and nevertheless permits greater manufacturing tolerances, said sensor being intended to be rapidly exchangeable when worn.

This object is achieved according to the invention by the characterising features of the main claim in conjunction with the features of the preamble.

As a result of the fact that the pendulum is a component of a coin insertion funnel which is connected detachably to the housing of the coin validator as a wearing part, it is possible to exchange the coin insertion funnel rapidly together with the pendulum without the entire coin validator requiring to be exchanged. As a result of the fact that the pivot point of the pendulum, which is articulated on the remaining part of the coin insertion funnel, is offset laterally to the first and second toothing, as observed in cross-section, in such a manner that the second toothing, in the insertion direction of the coin, becomes disengaged from the first toothing downwardly in an arc-shape, or the second toothing engages in the first toothing from below in an arc-shape, greater manufacturing tolerances are possible.

Advantageous developments and improvements are possible due to the measures indicated in the sub-claims.

As a result of the fact that a reflection coupler is used, the scanning is extremely sensitive since only small deviations from the initial position effect signal changes. In this way, also extremely thin and non-tensioned threads can be detected.

An embodiment of the invention is illustrated in the drawing and is explained in more detail in the subsequent description. There are shown:

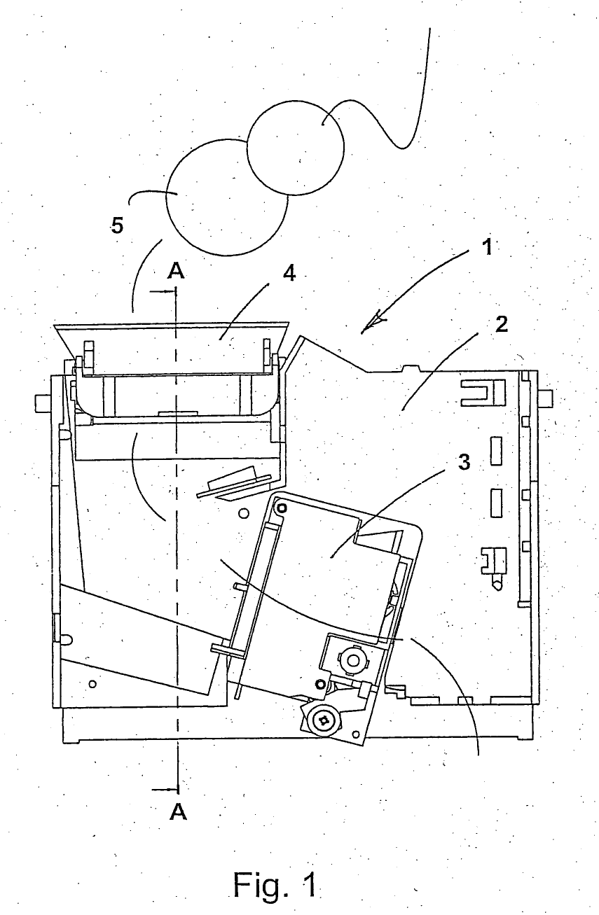

FIG. 1 a side view of a coin validator according to an embodiment of the invention,

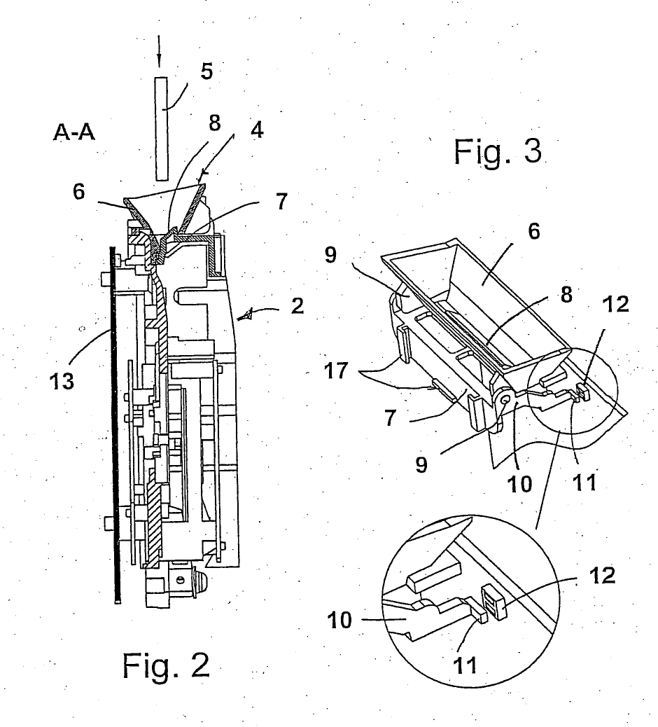

FIG. 2 a section corresponding to the section line A-A according to FIG. 1,

FIG. 3 a perspective view of a coin insertion funnel corresponding to the present invention,

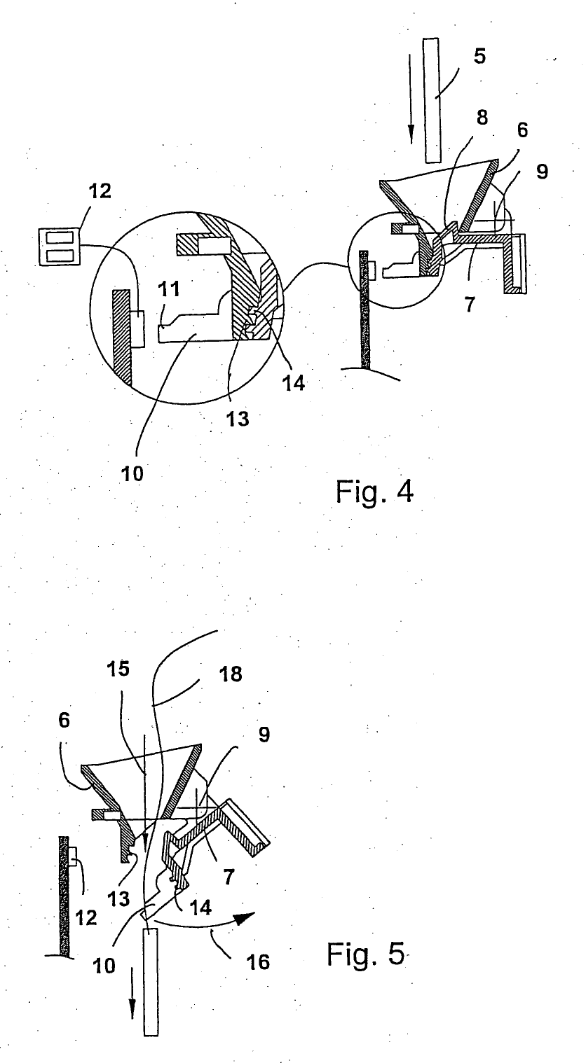

FIG. 4 a section view of the coin insertion funnel with switching device in the inoperative state,

FIG. 5 a section through the coin insertion funnel during insertion of a coin, and

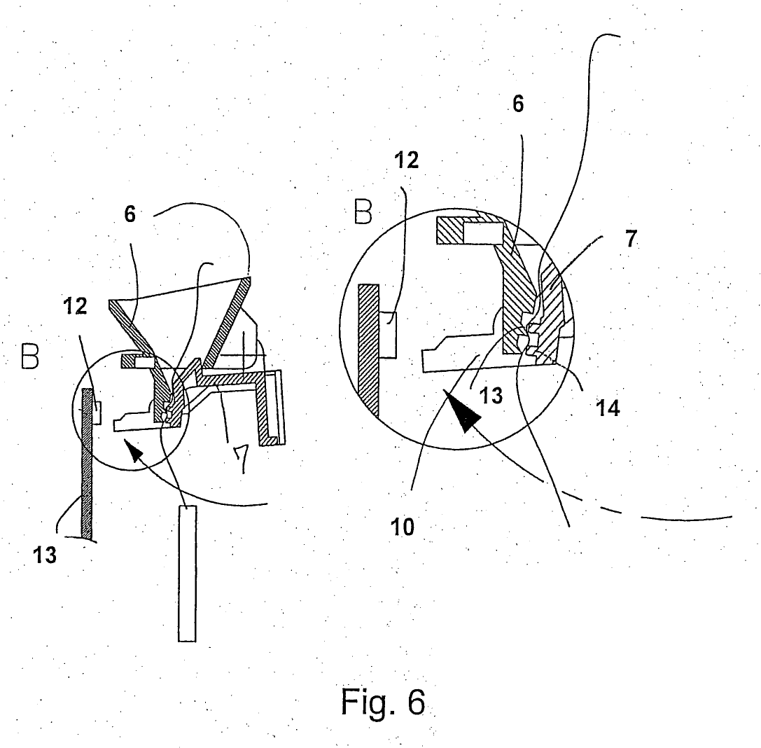

FIG. 6 a section through the coin insertion funnel according to the invention with a coin suspended on the thread.

The coin validator 1 illustrated in FIG. 1 has a housing 2 on or in which a validating device 3 is provided, which detects a coin 5 inserted in an insertion funnel 4 with respect to its parameters, said coin being evaluated by an evaluation and control unit, acceptance or return shafts being actuated dependent upon the result.

The coin insertion funnel 4, which is illustrated in more detail in FIG. 3, is connected detachably to the housing, preferably it has formed extensions which engage with the housing in a form-fitting manner. As can be detected in FIGS. 1 to 3, the coin insertion funnel comprises a part 6, which is stationary relative to the housing, said part having diagonal side walls and having a channel-shaped configuration, and a part which is pivotable relative to the stationary part 6 and designated as pendulum 7 and which, in the inoperative state, closes an outlet opening out of the stationary part 6, i.e. out of the coin insertion funnel. The pendulum 7 is provided with a diagonal face 8 which easily engages in the interior of the stationary part and to some extent completes the funnel shape and serves as impact face for a coin 5. In the region of the ends of one longitudinally-extending boundary wall of the coin insertion funnel 4, the stationary part 6 has projections 9 with an axis extension, on which projections the pendulum 7 is mounted pivotably.

An arm 10 is formed on the pendulum 7, as can be detected best in FIG. 3, said arm extending next to the actual coin insertion funnel 4 over the width thereof. The end 11 of the arm 10 is situated opposite a reflection coupler 12, as can be detected more precisely in FIG. 3 and FIG. 4. The reflection coupler 12 is disposed on a printed circuit board 13 (see FIG. 2), which is mounted on or in the housing 2 and which bears further electrical and electronic component parts. The reflection coupler 12 is connected to the evaluation and control device, not illustrated, and comprises an optical transmitter and receiver which are applied on a chip.

As can be detected in particular from FIGS. 4 to 6, the stationary part 6 of the coin insertion funnel 4 has a first toothing 13 in its lower region in the coin insertion direction and a second toothing 14 is formed in the pendulum 7, and in fact in the region which, in the inoperative state of the pendulum or of the coin validator, is situated opposite the region of the stationary part 6 with the toothing 13. The first toothing 13 is incorporated in the stationary part 6 as recesses, whilst the second toothing 14 is formed outwardly as projections. In the inoperative state, the toothings 13, 14, as shown in FIG. 2 and FIG. 4, engage in each other, the upper and thereto angled-off side faces of the teeth of the toothing 14, designated as operating faces, in the inoperative state, always move towards the second upper, backwardly projecting and thereto angled-off rear faces of the cavities of the first toothing 13, designated as stop faces. The arm 10 with its end 11 thereby stands opposite the reflection coupler 12 in such a manner that the radiation source or the transmitter, disposed on the reflection coupler, emits light or radiation towards the end 11, this preferably comprising light coloured material, such as white plastic material, and the receiver, which is likewise disposed on the reflection coupler 12, receiving the reflected radiation and converting this into an electrical signal. The switching arm 10 with the end 11 and reflection coupler 12 are thereby adjusted relative to each other in such a manner that the produced electrical signal, in the inoperative state of the pendulum 7 or of the coin validator, has a defined signal.

If a coin 5 is inserted into the coin funnel 4, corresponding to FIG. 4, it strikes the diagonal face 8 of the pendulum 7 which acts as a flap and pivots away downwardly out of the coin insertion track, which is indicated in FIG. 5 by the arrow 15, about the point of rotation 9 of the pendulum 7 or of the flap 7, corresponding to the direction which is indicated by the arrow 16. The switching arm 10 with the pendulum 7 thereby pivots away downwardly in an arc-shape and the light emitted from the transmitter of the reflection coupler 12 is no longer reflected, i.e. the receiver emits no signal. During passage of a correct coin, the pendulum 7 pivots back into the initial position, an additional weight being able to be provided which can be inserted on the side of the pendulum 7 opposite the toothing 14 in corresponding formed receiving means 17.

It should be noted that the projecting faces of the toothing 13 or of the tooth-shaped cavities in the stationary part 6 are configured such that they are designed diagonally downwardly in the insertion direction 15 in order that the toothing 14 on the pendulum or on the flap 7 can move into the toothing 13 in an arc-shape, i.e. similarly to how a door pivots until the respective operating and stop faces come into engagement or contact. The point of rotation 9 of the pendulum is far away from the reflection face of the switching arm 10 or from the toothing 13, as a result of which a large movement path of the pendulum or of the switching arm 10 is achieved in the smallest space and as a result of which it is made possible that the toothing 14 engages in the toothing 13 by an arcuate path. Due to such an articulation of the pendulum 7, the sensitivity of the switching device, which is formed by the switching arm 10 and the reflection coupler 12, on the one hand, is increased and, on the other hand, the manufacturing tolerances of the toothings 13, 14 can be increased since the operating faces of the pendulum always move towards the stop faces of the stationary part.

When a coin on a thread 18 is inserted, as is illustrated in FIG. 5 and FIG. 6, the pendulum 7 pivots away downwardly corresponding to the arcuate direction 16 and back again corresponding to FIG. 6. As can be detected in FIG. 6, the pendulum 7 or the switching arm 10 does not return into its initial position since the thread 18 prevents engagement of the toothings 13, 14 in each other. Hence no signal or no defined signal is emitted from the reflection body so that a so-called “thread signal” can be emitted from the evaluation and control device, which signal can trigger specific measures, such as an alarm or the like.

The mode of operation is intended to be summarised again in brief The position of the pendulum 7 or of the flap 7, in the inoperative position, is detected by the reflection coupler 12. Even a slight alteration in the switching arm 10 relative to the inoperative position leads to a response of the reflection coupler 12. In order that the arrangement reacts sensitively enough beyond all manufacturing tolerances, the current through the transmitter, which is configured for example as a light diode, of the reflection coupler is adjusted such that the evaluation circuit recognises a closed flap 7 precisely as such. Optionally, the current can be increased somewhat in order to obtain an adequate security spacing. A comparator is connected to the input of the actual evaluation device which can be configured as a microprocessor. The sensitivity of the reflection coupler can be determined by the response threshold of the comparator.

In order that a coin is accepted as valid, the pendulum or the flap 7 must have opened and shut again once, this requiring to take place within a time which the coin normally needs to travel from the coin insertion to a routing element for the coin acceptance or return. If one of the two switching states is missing, as occurs for example in the embodiment according to FIG. 6 in the case of a coin with thread, then the coin is rejected.

Another electrical evaluation is also possible, for example in a simplified mode of operation, it can be checked merely before actuation of a routing element whether the flap or the pendulum 7 is just closed, the coin only being accepted if this is the case. In the case of this simplified evaluation, the lower coin acceptance speed is however disadvantageous since it must be ensured in advance that no subsequent coin has just opened the flap at the decisive point in time. If the flap or the pendulum 7 has been opened by an inserted coin and has not closed again, at least temporarily, within a set time, then the evaluation circuit assumes that a coin which is suspended on the thread has been inserted and the thread, corresponding to FIG. 6, still keeps the flap open or does not allow it to return into the inoperative position. Consequently, the evaluation device generates the thread signal.

1. Coin validator having a thread sensor which is disposed in the region of the coin insertion channel, and having a coin validating device for controlling the acceptance or rejection of an inserted coin, the thread sensor having a first toothing, which is disposed on a stationary part of the coin insertion channel, and a second toothing, which is disposed on a pendulum, said toothings being disengaged upon insertion of a coin, and having a switching device which is in operational connection with the pendulum and emits a signal to the coin validating device upon insertion of a coin, characterised in that the pendulum is a component of a coin insertion funnel which is connected detachably to the housing of the coin validator as a wearing part and forms part of the coin insertion channel, the pivot point of the pendulum, which is articulated on the remaining part of the coin insertion funnel is offset laterally to the first and second toothing, as observed in cross-section, in such a manner that the second toothing, in the insertion direction of the coin, becomes disengaged from the first toothing downwardly in an arc-shape, or the second toothing engages in the first toothing from below in an arc-shape.

2. Coin validator according to claim 1, characterised in that the switching device is an optical switching device which has a light sensor and light receiver and also a switching arm acting on the light emitted from the light transmitter, said switching arm being connected to the pendulum.

3. Coin validator according to claim 2, characterised in that the light transmitter and light receiver are disposed next to each other on a chip and form a reflection coupler, the switching arm, in its inoperative state, being opposite the reflection coupler in a fixed association in order to reflect the light emitted from the light transmitter.

4. Coin validator according to claim 1, characterised in that the switching arm pivots in the same direction as the second toothing.

5. Coin validator according to claim 2, characterised in that the light transmitter and light receiver or the reflection coupler are mounted on a printed circuit board which is securely connected to the housing.

6. Coin validator according to claim 1, characterised in that the pendulum, on the side which is remote from the second toothing, has receiving projections for receiving a flat weight.

7. Coin validator according to claim 1, characterised in that the switching arm is disposed outwith the coin insertion opening of the coin insertion funnel.

8. Coin validator according to claim 1, characterised in that the first toothing is configured in such a manner that an arcuate insertion of the second toothing from below is possible.

9. Coin validator according to claim 1, characterised in that the coin insertion funnel forms a form-fitting connection with the housing.
